(19) United States
(12) Patent Application Publication
(10) Pub. No.: US 2012/0094105 A1
(43) Pub. Date: Apr. 19, 2012

(54) BAGASSE COMPOSITE, METHOD FOR PREPARING SAME AND INTERIOR MATERIAL USING SAME

(76) Inventor: Hee Lyong Ryu, Seoul (KR)

(21) Appl. No.: 13/379,938

(22) PCT Filed: Jun. 9, 2010
(86) PCT No.: PCT/KR2010/003679

§ 371 Date: Dec. 21, 2011

(30) Foreign Application Priority Data
Jun. 22, 2009 (KR) 10-2009-0055356

(51) Int. Cl. B32B 27/04; D21B 1/04

(52) U.S. Cl. 428/297.4; 264/115

(57) ABSTRACT

Disclosed are a bagasse composite, a method for preparing the composite, and an interior material using the same. More particularly, the composite includes 55-75 wt % of fibers and 25-45 wt % of thermoplastic polymer, wherein the fibers are obtained from bagasse and have a particle size of 40-120 mesh, and a length to diameter ratio of 3:1 to 5:1. Thus, the composite shows a high strength, and is not swelled. Also, the disclosed composite has similar natural texture and patterns to natural wood, and can be used for manufacturing a product capable of substituting for various interior materials and treated wood.

### TECHNICAL FIELD

The present invention relates to a composite used for manufacturing a product capable of substituting for an interior material (such as a flooring material, a lining material, a furniture material, a sound insulating wall, and fittings) and treated wood. More particularly, the present invention relates to a composite including fibers obtained from bagasse, and a thermoplastic polymer, a method for preparing the composite, and an interior material using the same.

### BACKGROUND ART

A consumer's preference for natural wood has recently largely increased. Also, as felling of the natural wood has increased carbon dioxide, an anxiety about environmental destruction has been amplified. Thus, a requirement for development of a material capable of substituting the natural wood has been increased, especially, in a case of construction materials with a great demand for natural wood.

In this background, research on a composite having a similar texture and appearance to natural wood has been recently actively conducted.

Accordingly, a composite including a small amount of wood, or a non-wood composite has been suggested. For example, a conventional composite is divided into a polywood type and an MDF (Medium Density Fiber wood) type. The polywood type of composite is prepared by slicing solid wood, coloring one side surface or both side surfaces of the wood, drying the wood, adhering a film, etc. on the wood through an adhesive, drying the wood, and cutting the wood into a predetermined length. The MDF is prepared by grinding solid wood or waste wood into powder, adding a large amount of resin to the powder, and heat-compressing the mixture. MDF may be attached with natural veneer or vinyl veneer, and then processed for an appropriate use.

However, such composite wood causes environmental pollution due to a harmful material included in the adhesive. Also, the MDF has a problem in that contraction/expansion occur between veneer and a panel board, and the attached veneer is separated, split, or rotten by attached external moisture, etc.

Also, Japanese Patent Publication No 1995-080809 (1995 Mar. 28) discloses a waterproof board using bagasse instead of wood. The waterproof board is prepared by mixing fibers (2-8 cm) and powder obtained by grinding bagasse, with a melamine resin and/or a phenol resin. However, in the preparation of the waterproof board, the melamine resin and/or the phenol resin as the adhesive adheres the fibers and the powder content with each other, instead of being impregnated into large-size fibers because the resins cannot be impregnated into the fibers due to the large size of the fibers. Accordingly, the waterproof board shows a low durability (such as strength) as compared to the case where a resin is impregnated into fibers. Also, the waterproof board has a problem in that the adhesion of the melamine resin and/or the phenol resin is lowered by exposure to liquid, etc. for a long time, and the board is easily broken or partly comes off. Also, the waterproof board is molded as a board by thermal compression molding, and thus cannot have a variety of shapes and forms. Furthermore, a material including the melamine resin and/or the phenol resin cannot be recycled, and thus is not environmentally friendly.

Accordingly, it is required to conduct research on a composite that does not use wood, has less distortion and high strength, and no discoloration even by exposure to sunlight, and is environmentally friendly.

### DISCLOSURE

### Technical Problem

An object of the present invention is to provide a high strength composite and a preparation method of the same, in which the composite can be safely used for a long time without deformation (such as breaking, splitting, distortion) and discoloration.

Also, another object of the present invention is to provide an interior material (such as a flooring material, a lining material, a furniture material, a sound insulating wall, fittings) using the composite.

### Technical Solution

In accordance with an aspect of the present invention, there is provided a composite including 55-75 wt % of fibers and 25-45 wt % of thermoplastic polymer, wherein the fibers are obtained from bagasse and have a particle size of 40-120 mesh, and a length to diameter ratio of 3:1 to 5:1.

In accordance with another aspect of the present invention, there is provided a method for preparing the composite, including the steps of: preparing bagasse having less than 5 wt % of water content by dehydrating the bagasse obtained as a by-product from a sugar refining process of sugar cane; collecting only fibers by placing the prepared bagasse on a conveyor belt having a screen mounted thereon and eliminating basts; softening the collected fibers by adding water thereto and pounding the fibers; grinding the softened fibers by using a scouring machine; melt-mixing 55-75 wt % of the prepared fibers with 25-45 wt % of a thermoplastic polymer at a high temperature; and extruding a fiber-polymer mixture.

Also, the present invention provides an interior material using the composite.

### Advantageous Effects

The inventive composite mainly uses bagasse, and thus is environmentally friendly. Also, it is formed with a high density due to a binding force between as the bagasse and the thermoplastic polymer (as main components). Thus, it is excellent in strength (such as tensile strength, flexural strength, impact strength) and elasticity, and also is not swelled. Furthermore, even if exposed to sunlight for a long time, discoloration is not caused.

Due to these physical characteristics, the composite is not broken or split by an external strong force. Also, the composite is not distorted because it is not swelled by liquids (such as rainwater and beverages) or sunlight.

Also, the inventive composite has similar natural texture and patterns to natural wood, and is light weight so as to be easily transported and constructed. Furthermore, it is less susceptible to attacks by a harmful insect, and thus can be used for a longer time than a wood-composite.

Also, such a composite can be recycled by being melted, and can be used for manufacturing a product capable of substituting for various interior materials (such as a flooring material, a lining material, a furniture material, a sound insulating wall, fittings) and treated wood.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram showing a method for preparing a composite according to a preferred embodiment of the present invention.

### BEST MODE FOR INVENTION

Hereinafter, exemplary embodiments of the present invention will be described with reference to the accompanying drawings.

The present invention provides a composite including fibers obtained from bagasse and a thermoplastic polymer, and a preparation method of the same, in which the composite is environmentally friendly, shows a high strength, and can be used as an interior material.

Hereinafter, the present invention will be described in detail.

The inventive composite includes 55-75 wt % of fibers obtained from bagasse, and 25-45 wt % of a thermoplastic polymer. Also, the composite may further include an additive besides the fibers and the thermoplastic polymer.

The bagasse used in the present invention is obtained as a by-product from a sugar refining process of sugar cane. The bagasse indicates a residue after squeezing saccharose from trunk (stalk) of sugar cane, and is white or light yellowish.

Such bagasse is sufficiently valuable as a material substituting for wood and fibers. Especially, since in the preparation of a composite substituting for a wood polymer composite using wood, an agricultural resource is utilized, the bagasse can perform an important role of improving the profitability of farms, and reducing the air pollution caused by incineration. Also, bagasse obtained after a sugar refining process of sugar cane has a density and a volume appropriate for transportation and storage, and thus can be easily used. The fibers used in the present invention are preferably ground into fine powder. Herein, the fibers have a particle size of 40 to 120 mesh, preferably of 80 to 100 mesh. The ground fibers preferably have a length-to-diameter ratio of 3:1 to 5:1.

The fibers and the thermoplastic polymer are molten at high temperature while the thermoplastic polymer is impregnated into the pores of the fibers so as to provide a fiber-polymer mixture. Meanwhile, when the fibers have a particle size of less than 40 mesh, the fibers and the polymer are not sufficiently combined with each other due to the large particle size of the fibers. Thus, the polymer or the fiber particle may be non-uniformly distributed. Also, in a case where the fibers have a particle size of greater than 120 mesh, when the fibers are mixed with the thermoplastic polymer, the thermoplastic polymer cannot be not impregnated into the pores of the fibers.

Also, when the fibers have a length-to-diameter ratio of less than 3:1, the polymer material cannot be sufficiently impregnated into the fibers. This may reduce the durability. On the other hand, when the fibers have a length-to-diameter ratio of greater than 5:1, it may be difficult to impregnate the thermoplastic polymer into the pores of the fibers due to the long length.

The fibers obtained from the bagasse are included in an amount of 55-75 wt %, preferably of 65-75 wt %. Herein, when the fibers are included in an amount of less than 55 wt %, the amount of the thermoplastic polymer is increased. This is not environmentally friendly. Also, when the fibers are included in an amount of greater than 75 wt %, the amount of the thermoplastic polymer is decreased. This reduces the strength of the composite, and also when exposed to water, the composite may be distorted.

The thermoplastic polymer is one kind or two or more kinds selected from the group including polypropylene (PP), polyethylene (PE), polystyrene (PS), polyethylene terephthalate (PET) and polyvinyl chloride (PVC). Also, as the thermoplastic polymer, waste plastic may be used.

Also, the fiber-polymer mixture prepared by the fibers and the thermoplastic polymer may further include an additive. The additive is included in an amount of 8-10 parts by weight with respect to 100 parts by weight of the fiber-polymer.

The additive is one kind or two or more kinds selected from the group including a binding material, an antioxidant, a UV stabilizer, a UV absorber, a lubricant, a mineral filler, a coloring agent, a flame retardant, a heat stabilizer, and a blowing agent. The inventive composite may be used for manufacturing an interior material such as a flooring material, a lining material, a furniture material, a sound insulating wall, and fittings, and herein, the kind of the additive varies according to the kind of the interior material.

The interior material includes interior materials for both inside and outside of a building.

For example, when the inventive composite is used for manufacturing a flooring material, 1-2 parts by weight of a UV stabilizer, 1-2 parts by weight of a UV absorber, 2-4 parts by weight of a coloring agent, and 1-2 parts by weight of a blowing agent are used with respect to 100 parts by weight of fibers-polymer. When the composite is used for manufacturing a lining material, a furniture material, or a sound insulating wall, 0.5-2 parts by weight of a mineral filler, 2-4 parts by weight of a flame retardant, and 2-4 parts by weight of a binding agent may be used with respect to 100 parts by weight of fibers-polymer. Also, when the composite is used for manufacturing fittings, 1-2 parts by weight of an antioxidant, 1-2 parts by weight of a heat stabilizer, 2-4 parts by weight of a flame retardant, 1-2 parts by weight of a lubricant, and 1-2 parts by weight of a coloring agent may be used with respect to 100 parts by weight of fibers-polymer. However, the present invention is not limited thereto, and other additives may be further used for manufacturing the interior material.

From among the additives, the binding agent is used for improving the binding force between the fibers and the thermoplastic polymer, the antioxidant blocks oxygen and ultraviolet rays and inhibits discoloration, the UV stabilizer inhibits discoloration caused by UV radiation, the UV absorber absorbs UV radiation, and the lubricant enhances the dispersion of fibers as fine powder. Also, the mineral filler inhibits deformation caused by an impact, heat or a load, the coloring agent colors a product, the flame retardant is used to provide a heat-resistant product, the heat stabilizer minimizes thermal decomposition during processing or use, and the blowing agent foams fibers.

The inventive composite is recyclable because it can be re-used by being melted.

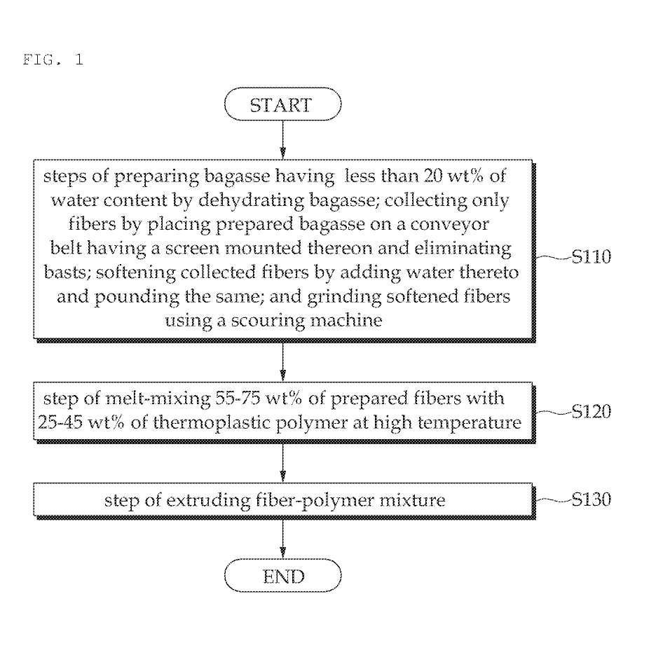

As shown in FIG. 1, the inventive method for preparing a composite includes the steps of: preparing fibers (S110), melt-mixing 55-75 wt % of the prepared fibers with 25-45 wt % of a thermoplastic polymer at a high temperature (S120), and extruding the fiber-polymer mixture (S130). The step (S110) of preparing the fibers includes the steps of preparing bagasse having less than 5 wt % of water content by dehydrating bagasse obtained as a by-product from a sugar refining process of sugar cane; collecting only fibers by placing the prepared bagasse on a conveyor belt having a screen mounted thereon and eliminating basts; and softening the collected fibers by adding water thereto and pounding the same; and grinding the softened fibers using a scouring machine. Also, between S120 and S130, a step of adding an additive may be further included.

In the step (S110) of preparing the fibers, the fibers are obtained from bagasse. In general, bagasse contains 20-40 wt % of water right after a sugar refining process. However, in the present invention, in order to separate basts (hearts) and fibers, the water content of bagasse has to be less than 5 wt %. If the water content is equal to or greater than 5 wt %, the basts are attached onto fibers. Thus it may be difficult to separately obtain only fibers, and the quality of a product may be lowered due to the occurrence of bubbles within the composite.

The dehydrated bagasse having less than 5 wt % of water content is moved on a conveyor belt having a screen mounted thereon while being separated into basts and fibers. On the conveyor belt, a screen with a size of 4.0-6.0 mm is mounted. Thus, basts are passed through the screen, and 90% or more of the basts drop, while the fibers are not passed through the screen, and moved along the conveyor belt so as to be collected at one position. The basts separated through screen make up about ⅓ of the bagasse, and the fibers are about ⅔ of the bagasse.

The screen has to have a mesh size through which a basts can be passed and fibers cannot be passed, and preferably has a size of 4.0-6.0 mm. The screen may be mounted on the conveyor belt by various methods without a specific limitation.

The conveyor belt is generally slightly shaken, and thus is advantageous in the process in which the bagasse is separated into basts and fibers. However, before being placed on the conveyor belt, the bagasse is more preferably slightly shaken so as to facilitate the separation of the basts from the fibers.

The fibers separated as described are washed with a sufficient amount of water. This is for removing dust included in the fibers, and a foreign substance (such as sugar) attached on the fibers after a sugar refining process, and may be selectively carried out according to the state of bagasse. Also, the number of times of the washing may be adjusted. In a conventional technology, a washing step using a chemical agent was required. However, the washing with water is enough for the present invention. After the washing, the water and the fibers are collected, and then following steps are carried out. The water used for the washing is recycled for washing through filtering.

The fibers from which the foreign substance has been removed are added with water again, and softened by being pounded and hashed. The content of water is not particularly limited. However, for convenience of pounding, the water is included in such a manner that the weight ratio of fibers to water is about 1:1. In the softening process, water makes the fibers damp. This allows the fibers to be softened without a chemical agent. The water used in this step can be also recycled.

A means for softening is not particularly limited. However, instead of a metallic machine, a wooden machine, for example, a wooden mortar is preferably used when pounded by a metallic means, the fibers may be deeply damaged or compressed and crushed. The pressure for the softening step may range from 1 to 2 kgf/c according to the amount of the fibers.

The softened fibers are dehydrated, and ground by a scouring machine (refinery) in such a manner that they can have a particle size of 40-120 mesh, and a length-to-diameter ratio of 3:1 to 5:1. As the scouring machine, a machine conventionally used in the art may be used. In general, wood is ground by a scouring machine in the forward direction. However, in the present invention, it is more preferable to drive the scouring machine in the reverse direction so that the fibers can become more sufficiently bulky.

The bagasse is hard. Thus, in a state where a sufficient amount of water is absorbed by the bagasse, the bagasse can be softened by being hashed. In the scouring machine, a disc may be rotated in the reverse direction instead of the forward direction so as to twist the fibers. This may allow the fibers to be more bulky and loosened, and thus improve the binding force between fibers. Accordingly, as the fibers become bulky, the binding force between fibers is increased in the preparation of the composite, thereby increasing the tensile strength.

In the step (S120) of mixing the fibers with the thermoplastic polymer, 55-75 wt % of the fibers prepared from S110 are melt-mixed with 25-45 wt % of the thermoplastic polymer at a high temperature of 150-200° C. so as to provide a fiber-polymer mixture. In the prepared fiber-polymer mixture, the thermoplastic polymer is impregnated into the pores of bulky fibers so as to improve the binding force between the fibers and the thermoplastic polymer, and to provide a high-density fiber-polymer mixture.

In the step (130) of extruding the fiber-polymer mixture, the fiber-polymer mixture prepared in S120 is extruded through thermal-compression at 130-140° C., 20-25 kgf/cm², for 15-20 minutes so as to provide a composite. The composite is molded by a molding structure, and cooled by cooling water so as to maintain the shape. Then, an interior material for the required use (inside or outside of a building) can be obtained.

After the step S120, a step of adding an additive according to the kind of an interior material may be further included.

Hereinafter, the present invention will be described with reference to Examples. However, the Examples below are only for illustrative purposes. Those skilled in the art will appreciate that various modifications, additions and substitutions are possible, without departing from the scope and spirit of the invention as disclosed in the accompanying claims.

### Example 1

Bagasse was prepared so that it can have 15 wt % of water content, and placed on a conveyor belt mounted with a screen with a size of 6.0 mm so as to separate basts. Then, fibers having a size of greater than 6.0 mm were obtained and residual fibers and basts were separated.

Herein, the fibers make up about ⅔ of the bagasse. The obtained fibers were cut into a size of 3 cm, and washed so as to remove remaining sugar and dust. The washed fibers were pounded and hashed together with water in a ratio of 1:1 for 5 minutes at 2 kgf/cm² so as to be softened. Herein, as a machine, instead of a metallic machine, a wooden mortar was used.

Then, the softened fibers were ground by a scouring machine in a beating process. Herein, the grinding was carried out in the reverse direction instead of the forward direction so that the fibers can be further bulky. The ground fibers have a particle size of 90 mesh, and a length to diameter ratio of 4:1.

70 g of the fibers was melt-mixed with 30 g of polypropylene at 170° C., and extruded at 140° C. at 20 kgf/cm² for 20 minutes so as to provide a composite.

### Example 2

A composite was obtained in the same manner as that of Example 1, except that before extruding, 1 g of a UV stabilizer, 2 g of a UV absorber, 4 g of a coloring agent, and 2 g of a blowing agent were added.

### Example 3

A composite was obtained in the same manner as that of Example 1, except that before extruding, 2 g of a mineral filler, 3 g of a flame retardant, and 3 g of a binding agent were added.

### Comparative Example 1

A composite was obtained in the same manner as that of Example 1, except that fibers having a particle size of 160 mesh were used.

### Comparative Example 2

A composite was obtained in the same manner as that of Example 1, except that fibers having a length to diameter ratio of 6:1 were used.

### Comparative Example 3

A composite was obtained in the same manner as that of Example 1, except that instead of fibers, 70 g of wood was used.

### Test Example

tensile strength (MPa): measurement of tensile strength (reference value: 12 MPa or more) in accordance with KS M 3006 (plastic tensile property test method)

flexural strength (MPa): measurement of flexural strength (reference value: 61˜82 MPa or more) in accordance with KS M ISO 178 (plastic flexibility test method)

bending elastic modulus (MPa): measurement of bending elastic modulus (reference value: 2100 MPa or more) in accordance with KS M ISO 178 (plastic flexibility test method)

absorptivity (%): measurement of moisture absorptivity (reference value: 3% or less) in accordance with KS M 3015 (plastic test method)

Impact strength (kgcm/cm²): measurement of impact strength (reference value: 12 kg cm/cm² or more) in accordance with KS M 3055 (plastic-izod impact strength test method)

dimensional change (%) in dampness: measurement of dimensional change in dampness (reference value: longitudinal direction 0.3% or less, thickness direction 2% or less) in accordance with KS F 3126 (decoration wood board dimensional change test method)

Table 1 below shows the comparison between Examples 1 to 3, and Comparative Examples 1 to 3 in the tests.

TABLE 1

| | | | | | Comp. | Comp. | Comp. |
|---|---|---|---|---|---|---|---|
| | | Ex. 1 | Ex. 2 | Ex. 3 | Ex. 1 | Ex. 2 | Ex. 3 |
| tensile strength(MPa) | | 15.1 | 15.4 | 15.1 | 7.1 | 8.8 | 4.4 |
| flexural strength(MPa) | | 80.8 | 81.0 | 79.8 | 56.1 | 55.2 | 47.9 |
| bending elastic modulus | | 3244 | 3256 | 3237 | 2018 | 1904 | 1895 |
| (MPa) | | | | | | | |
| absorptivity(%) | | 1.3 | 1.3 | 1.4 | 3.1 | 3.5 | 3.9 |
| impact strength | | 13.8 | 13.7 | 13.8 | 10.1 | 9.2 | 9.5 |
| (kg cm/cm²) | | | | | | | |
| dimensional | longitudinal | 0.01 | 0.01 | 0.01 | 0.4 | 0.5 | 0.9 |
| change | direction | | | | | | |
| ratio (%) | thickness | 0.1 | 0.15 | 0.1 | 1.5 | 2.2 | 2.7 |
| in dampness | direction | | | | | | |

As noted in table 1, the composites from Examples 1 to 3 are excellent in strength (such as tensile strength, flexural strength, impact strength) and elasticity, and are not swelled by undergoing little dimensional change.

Meanwhile, it was found that since a fiber particle size and a length to diameter ratio of the composites from Comparative Example 1 and 2 were not in accordance with the embodiment of the present invention, the strength and the elastic modulus were reduced. Furthermore, due to a large dimensional change, the composite was bent or lengthened. Also, as compared to Examples 1 to 3, the composites from Comparative Examples 1 to 3 showed a high absorptivity. Thus, it can be found that the durability of the composite was lowered.

Also, after the composites from Examples 1 to 3, and Comparative Examples 1 to 3 were exposed to UV radiation for 30 days, the discoloration was observed with the naked eye. As a result, as compared to the composites using the fibers obtained from bagasse, the composite using wood, from Comparative Example 3, gradually became yellowish.

1. A composite comprising 55-75 wt % of fibers and 25-45 wt % of thermoplastic polymer, wherein the fibers are obtained from bagasse and have a particle size of 40-120 mesh, the thermoplastic polymer is impregnated into the fibers, and a binding agent is included in an amount of 2 to 4 parts by weight with respect to 100 parts by weight of a fiber-polymer mixture.

2. The composite as claimed in claim 1, comprising 65-75 wt % of fibers, and 25-35 wt % of thermoplastic polymer.

3. The composite as claimed in claim 1, wherein the fibers have a particle size of 80-100 mesh.

4. The composite as claimed in claim 1, wherein the fibers have a length to diameter ratio of 3:1 to 5:1.

5. The composite as claimed in claim 1, wherein the thermoplastic polymer is at least one kind selected from the group including polypropylene, polyethylene, polystyrene, polyethylene terephthalate and polyvinyl chloride.

6. The composite as claimed in claim 1, wherein at least one kind selected from the group including an antioxidant, a UV stabilizer, a UV absorber, a lubricant, a mineral filler, a coloring agent, a flame retardant, a heat stabilizer and a blowing agent, and the binding agent are further included in an amount of 8-10 parts by weight with respect to 100 parts by weight of the fiber-polymer mixture.

7. A method for preparing a composite, comprising the steps of:
preparing bagasse having less than 5 wt % of water content by dehydrating the bagasse obtained as a by-product from a sugar refining process of sugar cane;
collecting only fibers by placing the prepared bagasse on a conveyor belt having a screen mounted thereon and eliminating basts;
softening the collected fibers by adding water thereto and pounding the fibers;
grinding the softened fibers by using a scouring machine;
melt-mixing 55-75 wt % of the prepared fibers with 25-45 wt % of a thermoplastic polymer at a high temperature; and
extruding a fiber-polymer mixture.

8. The method as claimed in claim 7, wherein the screen used in the step of collecting the fibers has a size of 4.0-6.0 mm.

9. The method as claimed in claim 7, wherein the step of grinding the fibers is carried out in a reverse direction of the scouring machine.

10. The method as claimed in claim 7, wherein in the step of melt-mixing the fibers with the thermoplastic polymer, the temperature ranges from 150 to 200° C.

11. The method as claimed in claim 7, wherein in the step of extruding the fiber-polymer mixture, extrusion is carried out at 20-25 kgf/cm², at 130-140° C. for 15-20 minutes.

12. An interior material comprising the composite as claimed in claim 1.
